(19) United States
(12) Patent Application Publication
(10) Pub. No.: US 2026/0111251 A1
(43) Pub. Date: Apr. 23, 2026

(54) System and Method for Managing Cloud Resources Through a Local Management Endpoint

(71) Applicant: Microsoft Technology Licensing, LLC, Redmond, WA (US)

(72) Inventors: Mauricio Josafat Garcia Vazquez, Sammamish, WA (US); Francis Manoj David, Bellevue, WA (US); Sushant Pramod Rewaskar, Woodinville, WA (US)

(21) Appl. No.: 18/923,336

(22) Filed: Oct. 22, 2024

(51) Int. Cl. G06F 9/455

(52) U.S. Cl. CPC G06F 9/45558; G06F 9/45541; G06F 2009/45595

(57) ABSTRACT

A computer-implemented method, computer program product and computing system for: defining a cloud compute instance within a cloud computing platform; and enabling access from the cloud compute instance to a local management endpoint within a local management service to enable management of at least one of the cloud compute instance and a cloud resource via the local management endpoint opened within the local management service while bypassing the at least one of the cloud frontend and the management layer.

### TECHNICAL FIELD

This disclosure relates to cloud resources and, more particularly, to systems managing such cloud resources.

### BACKGROUND

A cloud frontend is a user-friendly interface, typically web-based, that enables users to interact with cloud services and manage cloud resources. Serving as an intermediary between users and the underlying cloud infrastructure, it simplifies the process of provisioning, configuring, and monitoring cloud resources. The cloud frontend typically offers a graphical user interface (GUI), a command-line interface (CLI) or an Application Programming Interface (API) for user interaction, such as seen with the AWS Management Console, Google Cloud Console, and the Azure Portal. Users authenticate via credentials, and the frontend ensures that only authorized users can access and manage resources.

The frontend communicates with the cloud provider's backend services, allowing users to perform actions like creating virtual machines, configuring networks, and managing storage. Monitoring and management tools within the frontend provide dashboards and metrics for tracking the health and performance of cloud resources, along with options to set up alerts and manage logs.

Cloud frontends centralize management operations across all users before they are applied to backend infrastructure. This level of centralization introduces fundamental limitations in terms of load, scale and speed of management. While cloud frontends can be highly optimized, such fundamental limitations are problematic for ultra-low latency and hyper scale applications which have expectations for consistently fast management operations.

### BRIEF DESCRIPTION OF THE DRAWINGS

FIG. 1 is a diagrammatic view of a local management process in accordance with various embodiments of the present disclosure;

FIG. 2 is a flow chart of one implementation of the local management process of FIG. 1 in accordance with various embodiments of the present disclosure; and

FIG. 3 is a diagrammatic view of a computer system and the local management process of FIG. 1 coupled to a distributed computing network in accordance with various embodiments of the present disclosure.

Like reference symbols in the various drawings indicate like elements.

### DETAILED DESCRIPTION OF THE EMBODIMENTS

### Overview

Generally speaking, management of a cloud instance often requires the use of a cloud frontend that enables users to interact with cloud services and manage cloud resources. This frontend communicates with the cloud provider's backend services and allows users to perform actions concerning the cloud instance (e.g., creating virtual machines, configuring networks, managing compute and managing storage).

Often times, the user may be required to log into or access other systems (e.g., intermediate systems) before the user is able to access the cloud frontend. Examples of such intermediate systems may include but are not limited to intermediate networks or devices through which the user may access the cloud frontend. Accordingly, and to manage such a cloud instance, a user may be required to navigate a tortuous path of steps to effectuate such management of a cloud instance.

As will be discussed in greater detail below, the present disclosure enables more direct management of such a cloud instance. For example, a cloud compute instance may be defined within a cloud computing platform, wherein access between the cloud compute instance and a local management endpoint within a local management service may be established. Additionally, and through this local management endpoint within the local management service, the cloud compute instance and/or the cloud resource may be directly managed.

Specifically, such a local management endpoint within the local management service may enable direct management of cloud resources (e.g., cloud compute instances), while bypassing the need to navigate through the cloud frontend and the management layer. An example of such a local management endpoint may include a standard IP address for a cloud instance metadata provider (e.g., the well-known, non-routable IP address 169.254.169.254 for the Azure cloud). Accordingly and through the use of this local management endpoint, a user may be able to directly manage the functionality of the cloud compute instance, thus enabling the user to e.g., modify the instance size, manage the operating system and software, make adjustments to local or remote storage (e.g., adding more storage or upgrading to faster options like SSDs), set autoscaling rules, set load balancing rules, etc.

Accordingly, and using such a local management endpoint within the local management service, the user or an application (e.g., a cloud application) may directly manage such cloud resources. Such a direct-management configuration will reduce latency by reducing the number of hops needed to effectuate such management (e.g., since management does not need to occur through e.g., a cloud frontend and/or a management layer).

The details of one or more implementations are set forth in the accompanying drawings and the description below. Other features and advantages will become apparent from the description, the drawings, and the claims.

### Local Management Process:

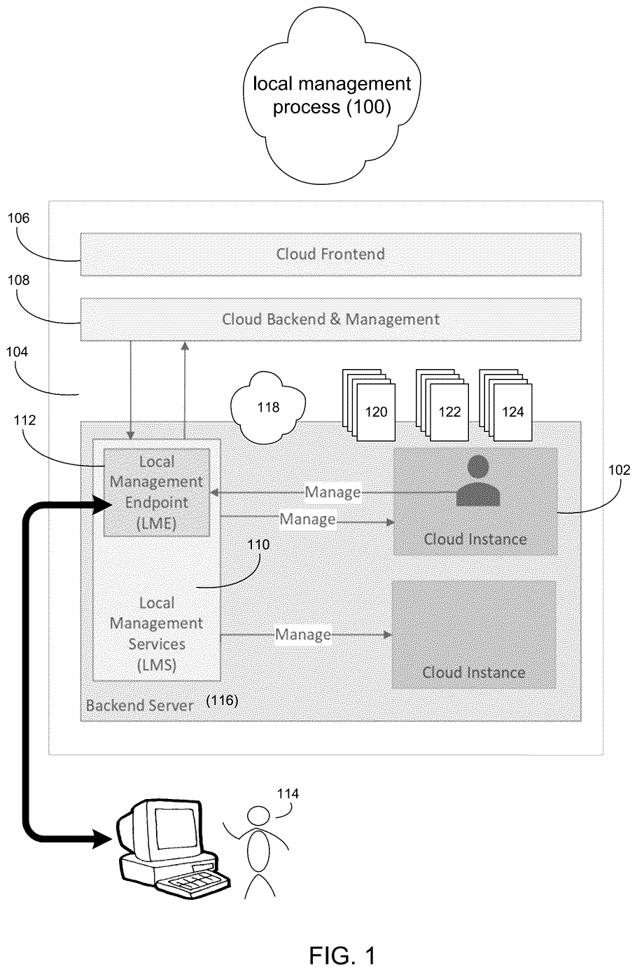

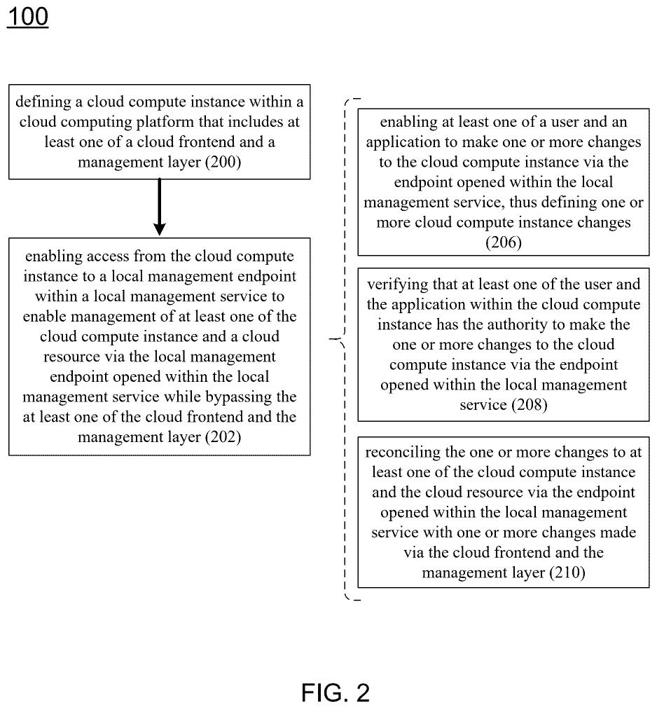

Referring to FIGS. 1-2, local management process 100 may define 200 cloud compute instance 102 within cloud computing platform 104.

Cloud Compute Instance: A cloud compute instance is typically a virtual server created within a cloud computing environment, providing a flexible, scalable, and cost-effective alternative to traditional physical servers. Each instance may operate as an independent server with its own allocated resources such as CPU, memory, storage, and network connectivity, and may run a variety of operating systems and applications. Users may configure cloud compute instances to meet specific requirements, selecting the appropriate size and type based on workload demands. For example, a cloud compute instance may be tailored for web hosting, application deployment, database management, development, and testing environments, or even high-performance computing tasks.

A cloud compute instance may be managed through the cloud service provider's interface (e.g., cloud frontend 106) or application programming interfaces (APIs), which may offer tools for provisioning, monitoring, and managing these instances. Management layer 108 may allow users to automate many tasks, such as scaling resources up or down, creating backups, and applying security updates. Since they are virtual, cloud compute instances (e.g., cloud compute instance 102) may be rapidly deployed and terminated, providing unmatched flexibility compared to traditional on-premises servers.

How Cloud Compute Instances Concern Cloud Computing Platforms: Cloud compute instances are a foundational element of cloud computing platforms (e.g., cloud computing platform 104), which may offer a comprehensive suite of services for building, deploying, and managing applications and infrastructure in the cloud. Platforms like Amazon Web Services (AWS), Microsoft Azure, and Google Cloud Platform (GCP) may provide a broad array of tools and services that revolve around the use of cloud compute instances.

These cloud computing platforms (e.g., cloud computing platform 104) may enable users to launch cloud compute instances on-demand, giving businesses the ability to scale their infrastructure dynamically in response to workload changes. For instance, during peak traffic periods, a business may quickly spin up additional instances to handle the load, and then scale back down during off-peak times, optimizing both performance and costs. This elasticity is a key advantage of cloud computing, allowing organizations to be more responsive and efficient.

Cloud compute instances (e.g., cloud compute instance 102) may also contribute to the resilience and reliability of applications. Cloud computing platforms (e.g., cloud computing platform 104) may offer features such as load balancing, autoscaling, and multi-region deployments, which may help ensure that applications remain available and performant even in the face of hardware failures or unexpected traffic spikes. Additionally, cloud platforms (e.g., cloud computing platform 104) may provide extensive security features, such as encryption, access controls, and compliance certifications, which may help protect the data and applications running on cloud compute instances.

Moreover, cloud compute instances (e.g., cloud compute instance 102) may facilitate innovation and development. Developers may quickly provision instances for development and testing, experiment with new technologies, and deploy applications in a fraction of the time it would take with traditional infrastructure. The ability to easily clone and snapshot instances also simplifies the process of creating development, staging, and production environments.

In summary, cloud compute instances (e.g., cloud compute instance 102) may be essential to cloud computing platforms (e.g., cloud computing platform 104) as they provide the compute power needed to run applications and services. Cloud compute instances (e.g., cloud compute instance 102) may enable scalability, flexibility, and cost-efficiency, making it easier for businesses to innovate and respond to changing demands. Cloud compute instances (e.g., cloud compute instance 102), may be managed through robust cloud platforms, supporting a wide range of use cases from simple web hosting to complex enterprise applications, driving the growth and adoption of cloud computing across industries.

As will be discussed below in greater detail, local management process 100 may enable access from the cloud compute instance (e.g., cloud compute instance 102) to a local management endpoint (to be discussed below) within a local management service (e.g., local management service 110).

A local management service (e.g., local management service 110) within a cloud computing platform (e.g., cloud computing platform 104) may refer to a suite of functionality provided by the cloud provider that allows users to manage and monitor cloud resources directly from within their cloud compute instances via a local management endpoint. This service may enable administrators to efficiently control, configure, and optimize their cloud resources without relying solely on the cloud provider's frontend or web-based management interfaces. Managing cloud compute instances through a local management service doesn't have inherent traditional cloud front-end limitations as they can be highly distributed and potentially run on (or close to) the same physical servers as the cloud compute instances. For the same reason, Local Management Service response times (latency) can be quite low given the direct communication between the source of the management request within the cloud compute instance and the cloud provider service that is going to materialize the management request on the cloud computing platform. The local management service may include capabilities such as resource management or monitoring. It may provide tools to provision, monitor, and manage virtual machines (VMs), storage, databases, and networking components. This may include the ability to start, stop, resize, and configure instances and other resources through a local management endpoint. Security and compliance features may help manage security policies, user access controls, and compliance requirements, including local authentication mechanisms, integration with existing identity management systems, and auditing tools to ensure regulatory compliance.

Monitoring and alerts may offer local dashboards and tools that provide real-time insights into the performance and health of cloud resources, with the ability to set up alerts and notifications for prompt response to potential issues. Hybrid cloud integration services may enable seamless integration between on-premises infrastructure and cloud resources, managing workloads that span both environments and ensuring data consistency and application performance across hybrid deployments.

Local management process 100 may enable 202 access from the cloud compute instance (e.g., cloud compute instance 102) to a local management endpoint (e.g., local management endpoint 112) within a local management service (e.g., local management service 110) management cloud compute instance 102 and/or the cloud resource (e.g., a storage cloud resource) via local management endpoint 112 opened within local management service 110 while bypassing the at least one of the cloud frontend (e.g., cloud frontend 106) and the management layer (e.g., management layer 108). This cloud resource may be related to the cloud compute instance (e.g., cloud compute instance 102), such as a storage cloud resource that is utilized by cloud compute instance 102.

As will be discussed below, the local management service (e.g., local management service 110) could be hosted on a server associated with the cloud compute instance (e.g., cloud compute instance 102) and/or as a local distributed service associated with the cloud compute instance (e.g., cloud compute instance 102).

For example, local management process 100 may provision a local IP address and port that may be assigned to (and routed to) the local management service (e.g., local management service 110). One example of such a local management endpoint (e.g., local management endpoint 112) may include but is not limited to the standard IP address for a cloud instance metadata provider. For example, within the Azure cloud, this is available at a well-known, non-routable IP address (169.254.169.254).

This local management endpoint (e.g., local management endpoint 112) within local management service 110 may enable direct management of cloud resources (e.g., cloud compute instance 102). Accordingly and through the use of local management endpoint 112 within local management service 110, a user (e.g., user 114) or an application (e.g., a cloud application) may directly manage a cloud resource (e.g., a storage cloud resource), thus minimizing latency by reducing the number of hops needed to effectuate such management (since it does not need to occur through e.g., cloud frontend 106 and/or management layer 108).

As discussed above, a user (e.g., user 114) of cloud resources (e.g., cloud compute instance 102) may traditionally be required to log into or access other systems (e.g., intermediate systems) before they are able to access the cloud service provider's interface (e.g., cloud frontend 106) or cloud service provider's management layer (e.g., management layer 108). Examples of such intermediate systems may include but are not limited to intermediate networks (e.g., the internet, an intranet, an extranet) or devices (e.g., various servers) through which user 114 may access the cloud service provider's interface (e.g., cloud frontend 106) or cloud service provider's management layer (e.g., management layer 108). Accordingly, local management process 100 may eliminate the need to navigate such a convoluted path of steps to effectuate such management of the cloud resources (e.g., cloud compute instance 102) through the use of local management endpoint 112 within local management service 110 that enables direct management of cloud resources (e.g., cloud compute instance 102), thus bypassing the at least one of the cloud frontend (e.g., cloud frontend 106) and the management layer (e.g., management layer 108).

Local management service 110 may be executed on a server (e.g., server 116) associated with cloud compute instance 102. This server (e.g., server 116) may represent a single physical server or a distributed group of servers.

As a variation, cloud compute instance 102 may be a BareMetal server instance hosted on the cloud computing platform (e.g., cloud computing platform 104). Bare metal hosting, in the context of cloud compute instance 102, refers to a type of cloud service where the user is provided with dedicated physical hardware without any virtualization layer. Unlike traditional cloud compute instances, which may run on virtual machines (VMs) that share underlying hardware resources with other VMs, bare metal hosting gives users full access to the physical server. Accordingly, the entire machine's resources—CPU, memory, storage, and network—are dedicated to a single user or tenant, offering maximum performance and control.

Alternatively, cloud compute instance 102 may be a virtualized server provisioned as a virtual machine by a hypervisor (e.g., hypervisor 118).

Hypervisor 118, in the context of a cloud compute instance (e.g., cloud compute instance 102), is a piece of software that enables virtualization by allowing multiple virtual machines (VMs) to run concurrently on a single physical server. Hypervisor 118 may play a crucial role in cloud computing platforms by managing the VMs and abstracting the server's physical resources like CPU, memory, and storage, so they can be dynamically allocated to different VMs according to demand.

The primary function of a hypervisor in cloud environments may be to create and manage these VMs. Each VM may act as an independent unit, capable of running its own operating systems and applications as if it were a separate physical device. This may allow cloud providers to offer scalable and flexible computing resources to multiple tenants, each isolated from the others, enhancing both security and stability.

Cloud compute instance 102 may also be provisioned as a container (e.g., container 122). In cloud computing, virtual machines (e.g., virtual machine 120) and containers (e.g., container 122) are two key technologies used for virtualizing resources.

A virtual machine (e.g., virtual machine 120) is essentially an emulation of a physical computer, complete with its own operating system. VMs may operate independently on physical hardware through a hypervisor, which is responsible for creating and managing multiple VMs on a single physical server. The hypervisor may allocate physical resources like CPU, memory, and storage to each VM, ensuring complete isolation from the host machine and other VMs. This isolation may enhance security and stability, making VMs suitable for applications that require robust separation, full control over the environment, or the need to run multiple different operating systems on the same hardware.

On the other hand, containers (e.g., container 122) are a lighter form of virtualization. These could be isolated via a hypervisor or via process-level namespace isolation. Managed by tools like Docker and Kubernetes, containers may encapsulate an application and its dependencies within a container image, making them highly efficient and portable. Containers may be quick to deploy and replicate, which suits dynamic and scalable environments well. Containers may ensure consistency across different deployment environments due to their portable nature, making them ideal for microservices architectures where different components of an application are developed, deployed, and scaled independently.

In a cloud context, the choice between VMs and containers may depend on specific needs: VMs may be preferred for tasks requiring complete OS isolation and environments demanding a specific OS, whereas containers may be better for applications that benefit from rapid scaling and high efficiency. Both technologies are pivotal in cloud computing, providing the necessary tools for developers and administrators to build effective and reliable software deployments in scalable environments.

When enabling 202 access from cloud compute instance 102 to local management endpoint 112 within local management service 110 to enable management of at least one of cloud compute instance 102 and a cloud resource (e.g., a storage cloud resource) via local management endpoint 112 opened within local management service 110 while bypassing the at least one of cloud frontend 106 and management layer 108, local management process 100 may enable 206 a user (e.g., user 114) or an application (e.g., a cloud application) to make one or more changes to cloud compute instance 102 and/or cloud resource (e.g., a storage cloud resource) via local management endpoint 112 opened within local management service 110, thus defining one or more cloud compute instance or resource changes (e.g., cloud compute instance changes 124)

Users (e.g., user 114) or an application (e.g., a cloud application) may make various changes (e.g., cloud compute instance changes 124) to cloud compute instance 102 via local management service 110 that is accessed through local management endpoint 112, including adjustments to configuration, scaling, security settings, and monitoring.

Such changes (e.g., cloud compute instance changes 124) may concern modifications to the instance size by changing the allocated compute resources like CPU and RAM based on application requirements. Users (e.g., user 114) or an application (e.g., a cloud application) may also manage the operating system and software, including updates and patches, and make adjustments to local or remote storage, such as adding more storage or upgrading to faster options like SSDs. Scaling and performance enhancements may be facilitated through features like auto-scaling, where users (e.g., user 114) or an application (e.g., a cloud application) may configure policies to automatically adjust the number of instances based on demand, ensuring performance during peak loads. Load balancing may be set up to distribute incoming traffic across multiple instances, improving reliability, and availability. Additionally, performance monitoring tools may enable users (e.g., user 114) or an application (e.g., a cloud application) to track metrics such as CPU utilization, memory usage, and network traffic. Security settings may be adjusted by defining firewall rules through security groups, controlling inbound and outbound traffic, and managing identity and access permissions with IAM roles and policies. Encryption may also be enabled for data-at-rest and data-in-transit to protect sensitive information. Backup and recovery options may allow users to initiate backups, take snapshots of instances, and configure disaster recovery plans for quick recovery and minimal downtime in case of incidents. Network settings, including IP addresses assignment and VPC configurations, may be customized to suit specific requirements.

Additionally and when enabling 202 access from cloud compute instance 102 to local management endpoint 112 within local management service 110 to enable management of at least one of cloud compute instance 102 and a cloud resource (e.g., storage cloud resource) via local management endpoint 112 opened within local management service 110 while bypassing the at least one of cloud frontend 106 and management layer 108, local management process 100 may verify 208 that the user (e.g., user 114) or an application (e.g., a cloud application) within cloud compute instance 102 has the authority to make the one or more changes to cloud compute instance 102 via local management endpoint 112 opened within local management service 110.

For example, local management process 100 may authenticate that the user (e.g., user 114) or an application (e.g., a cloud application) running within cloud compute instance 102 has the authority to make the one or more changes (e.g., cloud compute instance changes 124) to cloud compute instance 102 via local management endpoint 112 opened within the local management service (e.g., local management service 110).

Authenticating a user (e.g., user 114) or an application (e.g., a cloud application) running within cloud compute instance 102 in a cloud environment (e.g., cloud computing platform 104) may involve verifying the identity of an individual or entity seeking access to resources or services within the cloud infrastructure. This process may confirm that the user is who they claim to be by validating their credentials against a trusted source, such as a directory service or identity provider. Users (e.g., user 114) or an application (e.g., a cloud application) typically provide a combination of credentials, like a username and password, to initiate authentication. Applications running within a cloud compute instance may use credentials such as certificates, security tokens or Managed Identity credentials.

The cloud environment (e.g., cloud computing platform 104) may rely on an identity provider to manage user and application identities and authenticate and authorize them. This may be an internal directory service like Active Directory, an external identity provider like Okta or Azure Active Directory, or a cloud-based service provided by the cloud platform itself. Various authentication protocols, such as OAuth, OpenID Connect, SAML, or LDAP, may facilitate the secure exchange of authentication information between the user, the identity provider, and the cloud services. These protocols may ensure secure authentication and authorization processes.

The authentication process may begin with the user (e.g., user 114) or an application (e.g., a cloud application) attempting to access a cloud resource (e.g., a storage cloud resource) or service and providing their credentials. These credentials may be securely transmitted to the identity provider for verification. The identity provider then validates the user's credentials against its database or directory service. Upon successful verification, the identity provider may generate an authentication response indicating that the user (e.g., user 114) or an application (e.g., a cloud application) is authenticated. The cloud environment (e.g., cloud computing platform 104) may receive this response and may grant access to the requested resource or service based on the user's authenticated identity and associated permissions.

Proper user authentication in a cloud environment is essential for security, compliance, and a positive user experience, as it helps prevent unauthorized access to sensitive data and resources, ensures compliance with regulatory standards, enhances user experience by providing secure and convenient access to cloud services, and facilitates auditing and accountability through authentication logs and audit trails.

Further and when enabling 202 access from cloud compute instance 102 to local management endpoint 112 within local management service 110 to enable management of at least one of cloud compute instance 102 and a cloud resource (e.g., storage cloud resource) via local management endpoint 112 opened within local management service 110 while bypassing the at least one of cloud frontend 106 and management layer 108, local management process 100 may reconcile 210 the one or more changes to cloud compute instance 102 and/or the cloud resource (e.g., a storage cloud resource) via local management endpoint 112 opened within local management service 110 with one or more changes made via cloud frontend 106 and/or management layer 108.

Reconciling 210 one or more changes (e.g., cloud compute instance changes 124) may ensure that any actions effectuated on cloud compute instance 102 and/or a cloud resource (e.g., a storage cloud resource) via local management endpoint 112 are known by cloud frontend 106 and cloud management layer 108. In other words, such reconciliation maintains consistency and synchronization between cloud frontend 106, management layer 108 and cloud compute instance 102. Reconciliation is important for configuration consistency, ensuring that the changes (e.g., cloud compute instance changes 124) to cloud compute instance 102 and/or cloud resource (e.g., a storage cloud resource) are preserved and do not conflict with future changes made via the cloud frontend 106.

### System Overview

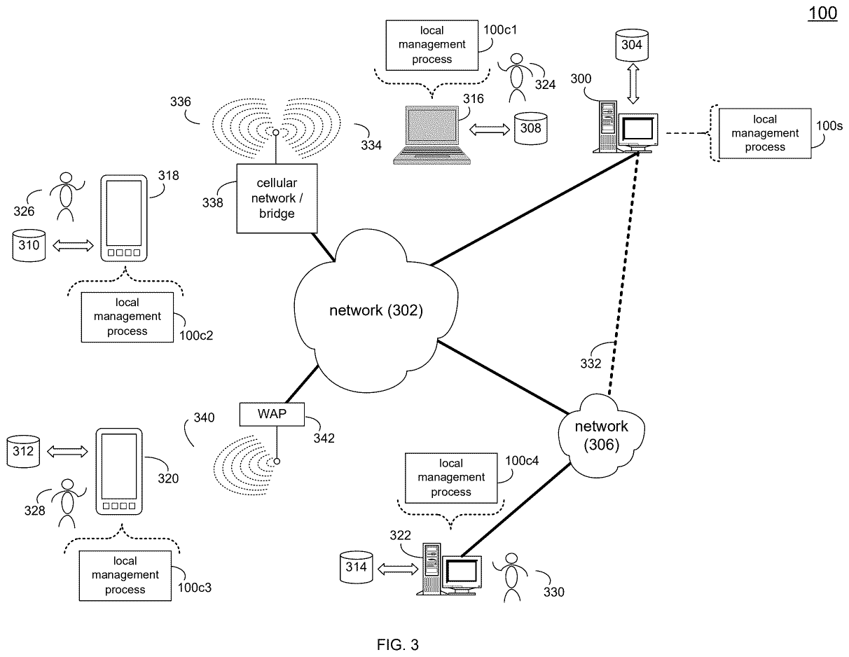

Referring to FIG. 3, there is shown local management process 100. Local management process 100 may be implemented as a server-side process, a client-side process, or a hybrid server-side/client-side process. For example, local management process 100 may be implemented as a purely server-side process via local management process 100s. Alternatively, local management process 100 may be implemented as a purely client-side process via one or more of local management process 100c1, local management process 100c2, local management process 100c3, and local management process 100c4. Alternatively still, local management process 100 may be implemented as a hybrid server-side/client-side process via local management process 100s in combination with one or more of local management process 100c1, local management process 100c2, local management process 100c3, and local management process 100c4.

Accordingly, local management process 100 as used in this disclosure may include any combination of local management process 100s, local management process 100c1, local management process 100c2, local management process 100c3, and local management process 100c4.

Local management process 100s may be a server application and may reside on and may be executed by computing device 300, which may be connected to network 302 (e.g., the Internet or a local area network). Examples of computing device 300 may include, but are not limited to: a personal computer, a server computer, a series of server computers, a mini computer, a mainframe computer, a smartphone, or a cloud-based computing platform.

The instruction sets and subroutines of local management process 100s, which may be stored on storage device 304 coupled to computing device 300, may be executed by one or more processors (not shown) and one or more memory architectures (not shown) included within computing device 300. Examples of storage device 304 may include but are not limited to: a hard disk drive; a RAID device; a random-access memory (RAM); a read-only memory (ROM); and all forms of flash memory storage devices.

Network 302 may be connected to one or more secondary networks (e.g., network 306), examples of which may include but are not limited to: a local area network; a wide area network; or an intranet, for example.

Examples of local management processes 300c1, 300c2, 300c3, 300c4 may include but are not limited to a web browser, a game console user interface, a mobile device user interface, or a specialized application (e.g., an application running on e.g., the Android platform, the iOS platform, the Windows platform, the Linux platform or the UNIX platform). The instruction sets and subroutines of local management processes 300c1, 300c2, 300c3, 300c4, which may be stored on storage devices 308, 310, 312, 314 (respectively) coupled to client electronic devices 316, 318, 320, 322 (respectively), may be executed by one or more processors (not shown) and one or more memory architectures (not shown) incorporated into client electronic devices 316, 318, 320, 322 (respectively). Examples of storage devices 308, 310, 312, 314 may include but are not limited to: hard disk drives; RAID devices; random access memories (RAM); read-only memories (ROM), and all forms of flash memory storage devices.

Examples of client electronic devices 316, 318, 320, 322 may include, but are not limited to a personal digital assistant (not shown), a tablet computer (not shown), laptop computer 316, smart phone 318, smart phone 320, personal computer 322, a notebook computer (not shown), a server computer (not shown), a gaming console (not shown), and a dedicated network device (not shown). Client electronic devices 316, 318, 320, 322 may each execute an operating system, examples of which may include but are not limited to Microsoft Windows, Android, iOS, Linux, or a custom operating system.

Users 324, 326, 328, 330 may access local management process 10 directly through network 302 or through secondary network 306. Further, local management process 10 may be connected to network 302 through secondary network 306, as illustrated with link line 332.

The various client electronic devices (e.g., client electronic devices 316, 318, 320, 322) may be directly or indirectly coupled to network 302 (or network 306). For example, laptop computer 316 and smart phone 318 are shown wirelessly coupled to network 302 via wireless communication channels 334, 336 (respectively) established between laptop computer 316, smart phone 318 (respectively) and cellular network/bridge 338, which is shown directly coupled to network 302.

Further, smart phone 320 is shown wirelessly coupled to network 302 via wireless communication channel 340 established between smart phone 320 and wireless access point (i.e., WAP) 342, which is shown directly coupled to network 302. Additionally, personal computer 322 is shown directly coupled to network 306 via a hardwired network connection.

WAP 342 may be, for example, an IEEE 802.11a, 802.11b, 802.11g, 802.11n, Wi-Fi, and/or Bluetooth device that is capable of establishing wireless communication channel 340 between smart phone 320 and WAP 342. As is known in the art, IEEE 802.11x specifications may use Ethernet protocol and carrier sense multiple access with collision avoidance (i.e., CSMA/CA) for path sharing. As is known in the art, Bluetooth is a telecommunications industry specification that allows e.g., mobile phones, computers, and personal digital assistants to be interconnected using a short-range wireless connection.

### GENERAL

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be used. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet.

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, not at all, or in any combination with any other flowcharts depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
defining a cloud compute instance within a cloud computing platform that includes at least one of a cloud frontend and a management layer; and
enabling access from the cloud compute instance to a local management endpoint within a local management service to enable management of at least one of the cloud compute instance and a cloud resource via the local management endpoint opened within the local management service while bypassing the at least one of the cloud frontend and the management layer.

2. The computer-implemented method of claim 1 wherein the cloud compute instance is one or more of:
a virtualized server provisioned as a virtual machine by a hypervisor;
a container; and
a baremetal server instance.

3. The computer-implemented method of claim 1 wherein the local management service is hosted on a server associated with the cloud compute instance.

4. The computer-implemented method of claim 1 wherein the local management service is hosted as a local distributed service associated with the cloud compute instance.

5. The computer-implemented method of claim 1 wherein enabling access from the cloud compute instance to a local management endpoint within a local management service to enable management of at least one of the cloud compute instance and a cloud resource via the local management endpoint opened within the local management service while the bypassing at least one of the cloud frontend and the management layer includes:
enabling at least one of a user and an application to make one or more changes to the cloud compute instance via the local management endpoint opened within the local management service, thus defining one or more cloud compute instance changes.

6. The computer-implemented method of claim 5 wherein enabling access from the cloud compute instance to a local management endpoint within a local management service to enable management of at least one of the cloud compute instance and a cloud resource via the local management endpoint opened within the local management service while bypassing the at least one of the cloud frontend and the management layer further includes:
verifying that at least one of the user and the application within the cloud compute instance has the authority to make the one or more changes to the cloud compute instance via the local management endpoint opened within the local management service.

7. The computer-implemented method of claim 6 wherein enabling access from the cloud compute instance to a local management endpoint within a local management service to enable management of at least one of the cloud compute instance and a cloud resource via the local management endpoint opened within the local management service while bypassing the at least one of the cloud frontend and the management layer further includes:
reconciling the one or more changes to at least one of the cloud compute instance and the cloud resource via the local management endpoint opened within the local management service with one or more changes made via the cloud frontend and the management layer.

8. A computer program product residing on a computer readable medium having a plurality of instructions stored thereon which, when executed by a processor, cause the processor to perform operations comprising:
defining a cloud compute instance within a cloud computing platform that includes at least one of a cloud frontend and a management layer; and
enabling access from the cloud compute instance to a local management endpoint within a local management service to enable management of at least one of the cloud compute instance and a cloud resource via the local management endpoint opened within the local management service while bypassing the at least one of the cloud frontend and the management layer.

9. The computer program product of claim 8 wherein the cloud compute instance is one or more of:
a virtualized server provisioned as a virtual machine by a hypervisor;
a container; and
a baremetal server instance.

10. The computer program product of claim 8 wherein the local management service is hosted on a server associated with the cloud compute instance

11. The computer program product of claim 8 wherein the local management service is hosted as a local distributed service associated with the cloud compute instance.

12. The computer program product of claim 8 wherein enabling access from the cloud compute instance to a local management endpoint within a local management service to enable management of at least one of the cloud compute instance and a cloud resource via the local management endpoint opened within the local management service while bypassing the at least one of the cloud frontend and the management layer includes:
enabling at least one of a user and an application to make one or more changes to the cloud compute instance via the local management endpoint opened within the local management service, thus defining one or more cloud compute instance changes.

13. The computer program product of claim 12 wherein enabling access from the cloud compute instance to a local management endpoint within a local management service to enable management of at least one of the cloud compute instance and a cloud resource via the local management endpoint opened within the local management service while bypassing the at least one of the cloud frontend and the management layer further includes:
verifying that at least one of the user and the application within the cloud compute instance has the authority to make the one or more changes to the cloud compute instance via the local management endpoint opened within the local management service.

14. The computer program product of claim 13 wherein enabling access from the cloud compute instance to a local management endpoint within a local management service to enable management of at least one of the cloud compute instance and a cloud resource via the local management endpoint opened within the local management service while bypassing the at least one of the cloud frontend and the management layer further includes:
reconciling the one or more changes to at least one of the cloud compute instance and the cloud resource via the local management endpoint opened within the local management service with one or more changes made via the cloud frontend and the management layer.

15. A computing system including a processor and memory configured to perform operations comprising:
defining a cloud compute instance within a cloud computing platform that includes at least one of a cloud frontend and a management layer; and
enabling access from the cloud compute instance to a local management endpoint within a local management service to enable management of at least one of the cloud compute instance and a cloud resource via the local management endpoint opened within the local management service while bypassing the at least one of the cloud frontend and the management layer.

16. The computing system of claim 15 wherein the cloud compute instance is one or more of:
a virtualized server provisioned as a virtual machine by a hypervisor;
a container; and
a baremetal server instance.

17. The computing system of claim 15 wherein the local management service is:
hosted on a server associated with the cloud compute instance; and/or
hosted as a local distributed service associated with the cloud compute instance.

18. The computing system of claim 15 wherein enabling access from the cloud compute instance to a local management endpoint within a local management service to enable management of at least one of the cloud compute instance and a cloud resource via the local management endpoint opened within the local management service while bypassing the at least one of the cloud frontend and the management layer includes:
enabling at least one of a user and an application to make one or more changes to the cloud compute instance via the local management endpoint opened within the local management service, thus defining one or more cloud compute instance changes.

19. The computing system of claim 18 wherein enabling access from the cloud compute instance to a local management endpoint within a local management service to enable management of at least one of the cloud compute instance and a cloud resource via the local management endpoint opened within the local management service while bypassing the at least one of the cloud frontend and the management layer further includes:
verifying that at least one of the user and the application within the cloud compute instance has the authority to make the one or more changes to the cloud compute instance via the local management endpoint opened within the local management service.

20. The computing system of claim 19 wherein enabling access from the cloud compute instance to a local management endpoint within a local management service to enable management of at least one of the cloud compute instance and a cloud resource via the local management endpoint opened within the local management service while bypassing the at least one of the cloud frontend and the management layer further includes:
reconciling the one or more changes to at least one of the cloud compute instance and the cloud resource via the local management endpoint opened within the local management service with one or more changes made via the cloud frontend and the management layer.
